(19) United States
(12) Patent Application Publication
(10) Pub. No.: US 2025/0247590 A1
(43) Pub. Date: Jul. 31, 2025

(54) OPERATION METHOD OF RADIATION IMAGING APPARATUS AND RADIATION IMAGING APPARATUS

(71) Applicant: CANON KABUSHIKI KAISHA, Tokyo (JP)

(72) Inventors: MASATO OFUJI, GUNMA (JP); MASAO INA, KANAGAWA (JP)

(21) Appl. No.: 19/024,693

(22) Filed: Jan. 16, 2025

(30) Foreign Application Priority Data
Jan. 25, 2024 (JP) 2024-009602

(51) Int. Cl. H04N 23/30; H04N 25/766; H04N 25/767; H04N 25/78

(52) U.S. Cl. CPC H04N 23/30; H04N 25/766; H04N 25/767; H04N 25/78

(57) ABSTRACT

A method of operating a radiation imaging apparatus that includes a plurality of pixels each including a conversion element configured to convert radiation or light into an electric charge and accumulate the electric charge, and a switching element configured to read an electrical signal corresponding to the electric charge from the conversion element. The method includes measuring an amount of electric charge while the switching element transitions from a non-conductive state to a conductive state or from a conductive state to a non-conductive state; and determining a characteristic of the switching element based on the measured amount of electric charge.

### BACKGROUND

### Field

The present disclosure relates to an operation method of a radiation imaging apparatus and the radiation imaging apparatus.

### Description of the Related Art

There is a radiation imaging apparatus in which a scintillator, a drive circuit, and the like are arranged on a sensor substrate on which pixels, each including a photoelectric conversion element such as a p-intrinsic-n (pin) diode and a switching element such as a thin film transistor (TFT), are formed in a two-dimensional matrix. Such a radiation imaging apparatus is used not only for a medical purpose aiming at image diagnosis but also for an industrial purpose such as electronic component inspection or piping inspection. For purposes of electronic component inspection, there is a need to achieve a high resolution and a high frame rate. Thus, an oxide TFT using an oxide semiconductor for a channel layer is used as a TFT.

If the radiation imaging apparatus is used for a long time, the threshold voltage of the switching element varies due to the influence of a voltage applied to the switching element and X-rays with which the switching element is irradiated, and the quality of a captured image may deteriorate. Japanese Patent Laid-Open No. 2023-95507 discusses, as a means for detecting deterioration in quality and the life of a radiation imaging apparatus caused by the deterioration, a method of measuring the threshold voltage of a switching element in a radiation imaging apparatus.

In the method discussed in Japanese Patent Laid-Open No. 2023-95507, however, it is necessary to supply, to the control electrode of the switching element, at least two or more different non-conducting potentials in addition to a conducting potential, and to allow a bias power supply to supply a plurality of potentials. Therefore, the apparatus configuration is complicated. In addition, it is necessary to wait for the leakage current of the switching element to stabilize, which may extend the time needed to perform the measurement.

### SUMMARY

The present disclosure has been made in consideration of the above situation, and provides a technique advantageous in determining the characteristic of a switching element in a radiation imaging apparatus.

According to an aspect of the disclosure, there is provided a method of operating a radiation imaging apparatus. The radiation imaging apparatus includes a plurality of pixels, with each pixel of the plurality of pixels including a conversion element configured to convert radiation or light into an electric charge and to accumulate the electric charge, and a switching element configured to read an electrical signal corresponding to the electric charge; a bias power supply configured to supply a bias potential to the conversion element via a bias line; a drive circuit configured to supply a control signal to a control electrode of the switching element via a drive line and to control the switching element; a readout circuit configured to read an electrical signal from the switching element via a signal line; and a controller. The method includes measuring an amount of electric charge based on a current flowing through one of the signal line, the bias line, and the drive line while the switching element transitions from a non-conductive state to a conductive state or from a conductive state to a non-conductive state; and determining, by the controller, a characteristic of the switching element based on the measured amount of electric charge.

Further features of the present disclosure will become apparent from the following description of exemplary embodiments with reference to the attached drawings.

### BRIEF DESCRIPTION OF THE DRAWINGS

FIG. 1 is a block diagram of a radiation imaging system according to a first embodiment;

FIG. 2A shows a part of a circuit diagram of a radiation imaging apparatus according to the first embodiment;

FIG. 2B is an expanded view of a part of the circuit diagram of FIG. 2A according to the first embodiment;

FIG. 3 is a flowchart of an operation method according to the first embodiment;

FIG. 4 is a timing chart of the operation method according to the first embodiment;

FIG. 5A is a circuit diagram explaining measurement of an amount of electric charge according to the first embodiment;

FIG. 5B is a graph explaining measurement of an amount of electric charge according to the first embodiment;

FIG. 5C is a graph explaining measurement of an amount of electric charge according to the first embodiment;

FIG. 6A is a timing chart explaining a modification of the first embodiment;

FIG. 6B is a timing chart for explaining the modification of the first embodiment;

FIG. 7A is a graph explaining the modification of the first embodiment;

FIG. 7B is a graph explaining the modification of the first embodiment;

FIG. 8 shows a part of a circuit diagram of a radiation imaging apparatus according to a second embodiment; and

FIG. 9 is a circuit diagram explaining measurement of an amount of electric charge according to the second embodiment.

### DESCRIPTION OF THE EMBODIMENTS

Hereinafter, embodiments will be described in detail with reference to the attached drawings. Note, the following embodiments are not intended to limit the scope of the appended claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

### First Embodiment

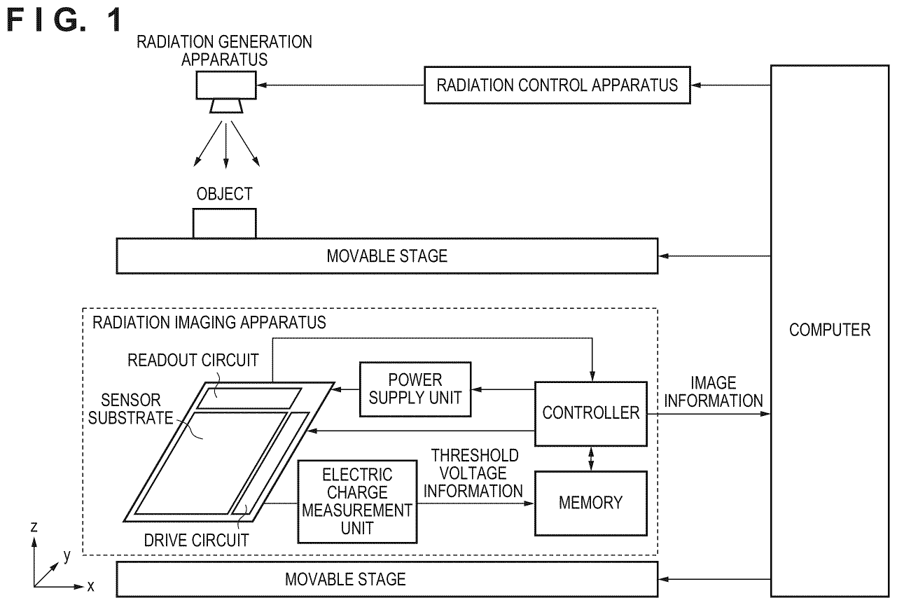

A radiation imaging system for electronic component inspection, to which this embodiment can be applied, will be described with reference to FIG. 1. A radiation generation apparatus can perform radiation irradiation toward the lower side (−z direction) in FIG. 1. While a movable stage on which an inspection target (object) is placed and a movable stage to which a radiation imaging apparatus is attached each make a motion in an xy-plane, the radiation imaging apparatus can continuously acquire an image. A radiation control apparatus can supply, to the radiation generation apparatus, a high voltage necessary for radiation generation and a signal for controlling radiation generation/stop. The radiation imaging system may include a computer. The computer controls the radiation control apparatus, the movable stages, and the radiation imaging apparatus. The computer can cause the radiation imaging apparatus to perform operations such as an imaging operation, a threshold voltage measurement operation to be described later, and to detect or determine at least one characteristic of a switching element.

The radiation imaging apparatus includes a sensor substrate configured to detect radiation, a readout circuit configured to read electric charge information from the sensor substrate, a drive circuit configured to control driving of the sensor substrate, and a power supply unit configured to supply a voltage to these. In addition, the radiation imaging apparatus includes an amount of electric charge measurement unit used to measure the threshold voltage of the switching element for each pixel or each region. A dedicated amount of electric charge measurement unit may be provided, or another element in the radiation imaging apparatus may also serve as an amount of electric charge measurement unit.

In this embodiment, the readout circuit can function as an amount of electric charge measurement unit. In addition, the radiation imaging apparatus can include a controller configured to control the sensor substrate, the readout circuit, the drive circuit, and the power supply unit. The controller can control transition between steps such as a threshold voltage measurement operation to be described later, and control the function of the radiation imaging apparatus. In addition, the controller may form a two-dimensional image based on output information from the readout circuit. The radiation imaging apparatus may further include a memory.

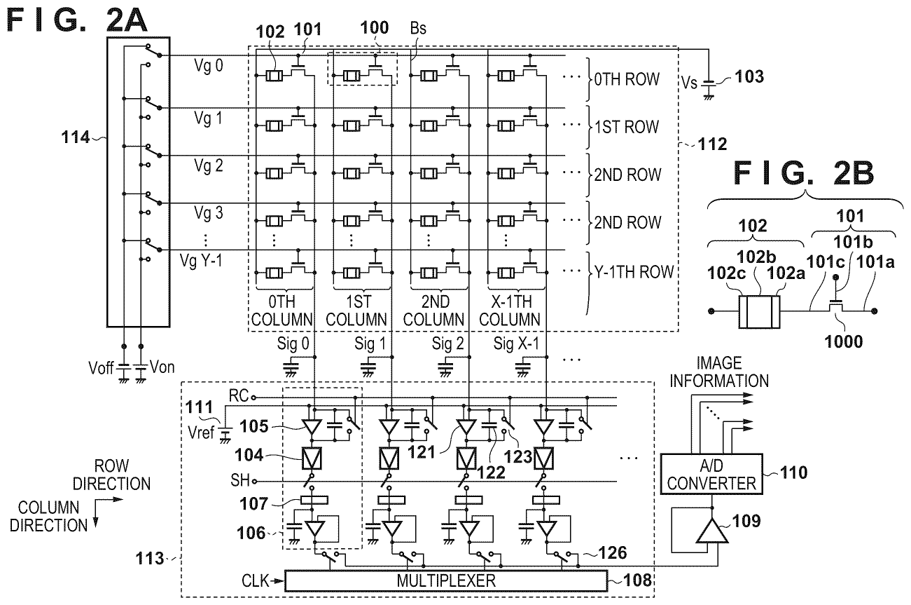

The radiation imaging apparatus will be described with reference to FIGS. 2A and 2B. The radiation imaging apparatus includes a drive circuit 114, a sensor substrate 112, a bias power supply 103, and a readout circuit 113. In this embodiment, the readout circuit 113 can function as a unit for measuring an amount of electric charge. The radiation imaging apparatus may further include an output buffer amplifier 109, an analog/digital (A/D) converter 110, and a controller. The controller can generate an image signal by processing an output from the A/D converter 110, and detect at least one characteristic of the switching element of the pixel. The sensor substrate 112 is a sensor in which pixels 100 each configured to detect radiation are arranged in a two-dimensional matrix forming a plurality of rows and a plurality of columns.

FIG. 2A shows only some of the pixels 100 on the sensor substrate 112 to simplify the description but an actual sensor substrate includes more pixels. For example, on a sensor substrate having a size of 17×17 inches, pixels of about 2800 rows×about 2800 columns can be arranged. An example of the circuit of the pixel 100 will be described with reference to FIG. 2B. The pixel 100 includes a conversion element 102 configured to convert radiation or light into an electric charge, and a switching element 101 configured to output an electrical signal corresponding to the electric charge of the conversion element. The switching element 101 is a transistor such as a TFT, and includes a gate electrode 101b, a source electrode 101c, a drain electrode 101a, and a channel layer 1000. From the viewpoint of increasing the speed and resolution of the radiation imaging apparatus, an oxide semiconductor, for example, an amorphous oxide semiconductor such as Indium-Gallium-Zinc-Oxygen (IGZO) or Indium-Zinc-Oxygen (IZO) can be used for the channel layer 1000.

The conversion element 102 is an indirect conversion element or a direct conversion element and converts irradiated radiation into an electric charge. An indirect conversion element includes a wavelength converter that converts radiation into light, and a photoelectric conversion element that converts the light into an electric charge. A direct conversion element directly converts radiation into an electric charge. In this embodiment, as the indirect conversion element, a p-intrinsic-n diode containing amorphous silicon (a-Si) as the main material is used. The conversion element 102 includes an individual electrode 102a, a common electrode 102c, and a photoelectric conversion layer 102b sandwiched between these and containing a-Si as the main material. Assume that the photoelectric conversion layer 102b is a p-intrinsic-n diode whose conductivity type is n+ on the side close to the individual electrode 102a, and p+ on the side close to the common electrode 102c. The individual electrode 102a is connected to the source electrode 101c of the switching element 101, and the common electrode 102c is electrically connected to the bias power supply 103 via a common bias line Bs.

In this embodiment, the bias line Bs extends in the column direction but may extend in the row direction. The gate electrodes 101b of the switching elements of the pixels of the kth row (k=0 to Y−1) are commonly connected to a drive line Vg k (k=0 to Y−1). In addition, the drain electrodes 101a of the switching elements of the pixels of the jth column (j=0 to X−1) are commonly connected to a signal line Sig j (j=0 to X−1) provided for each column. The source electrode 101c of each switching element is connected to the individual electrode 102a of the conversion element of each pixel.

The drive line Vg k (k=0 to Y−1) provided for each row is connected to the control electrodes of the switching elements of each row. The drive circuit 114 is, for example, a shift register, and supplies a control signal to the switching elements 101 via drive lines Vg 0, Vg 1, Vg 2, . . . , thereby controlling the conductive states of the switching elements 101.

In the readout circuit 113, an amplification circuit 106 configured to amplify the electrical signal of each signal line Sig is provided in correspondence with the signal line Sig. Each amplification circuit 106 includes an integral amplifier 105, a variable gain amplifier 104, and a sample and hold circuit 107. The integral amplifier 105 amplifies the electrical signal of the signal line. The variable gain amplifier 104 amplifies, by a variable gain, the electrical signal from the integral amplifier 105. The sample and hold circuit 107 samples and holds the electrical signal amplified by the variable gain amplifier 104.

The integral amplifier 105 includes an operational amplifier 121 that amplifies the electrical signal of the signal line and outputs it, an integral capacitor 122, and a reset switch 123. The integral amplifier 105 can change the gain (amplification factor) by changing the value of the integral capacitor 122.

The integral amplifier 105 can integrate an input current for a predetermined period, and output it as a voltage signal. This allows the integral amplifier 105 to integrate a current flowing to the integral amplifier 105 while the potential of the drive line Vg k transitions from Voff to Von, and to output a voltage signal. Since the integrated value of the current is an amount of electric charge, an amount of electric charge based on the current input to the integral amplifier 105 can be measured from the output voltage of the integral amplifier 105.

The readout circuit 113 includes a switch 126 for each column, and a multiplexer 108. The multiplexer 108 sequentially sets the switch 126 of each column in the conductive state, thereby sequentially outputting electrical signals, which are output from the amplification circuits 106 in parallel, as a serial signal to the output buffer amplifier 109. The output buffer amplifier 109 performs impedance conversion of the electrical signal and outputs it. The analog/digital (A/D) converter 110 converts the analog electrical signal output from the output buffer amplifier 109 into a digital electrical signal and outputs it to the controller.

The drive circuit 114 outputs a control signal having the conducting potential Von for setting the switching element in the conductive state or the non-conducting potential Voff for setting the switching element in the non-conductive state to the drive lines Vg 0, Vg 1, Vg 2, . . . .

The power supply unit supplies a reference potential Vref to the noninverting input terminal of each operational amplifier, supplies a bias potential Vs to the bias power supply 103, and supplies the conducting potential Von and the non-conducting potential Voff to the drive circuit. To apply a reverse bias to the conversion element 102 to sufficiently deplete the photoelectric conversion layer 102b and cause it to perform photoelectric conversion, the bias potential Vs is set to sufficiently be a negative potential with respect to the reference potential Vref. For example, Vs−Vref=−2 to −10 V.

To quickly perform signal charge transfer from the conversion element, the conducting potential Von is set to a sufficiently large positive potential such that the switching element is set in a complete conductive state. For example, Von−Vref=+20 to +5 V is set. The non-conducting potential Voff controls the switching element to be set in a complete non-conductive state. In other words, Voff is set to a sufficiently large negative potential such that the leakage current between the drain and the source in the switching element becomes so small (10⁻¹⁴ A or less) that it can be neglected. For example, Voff−Vref=−5 to −20 V is preferably set.

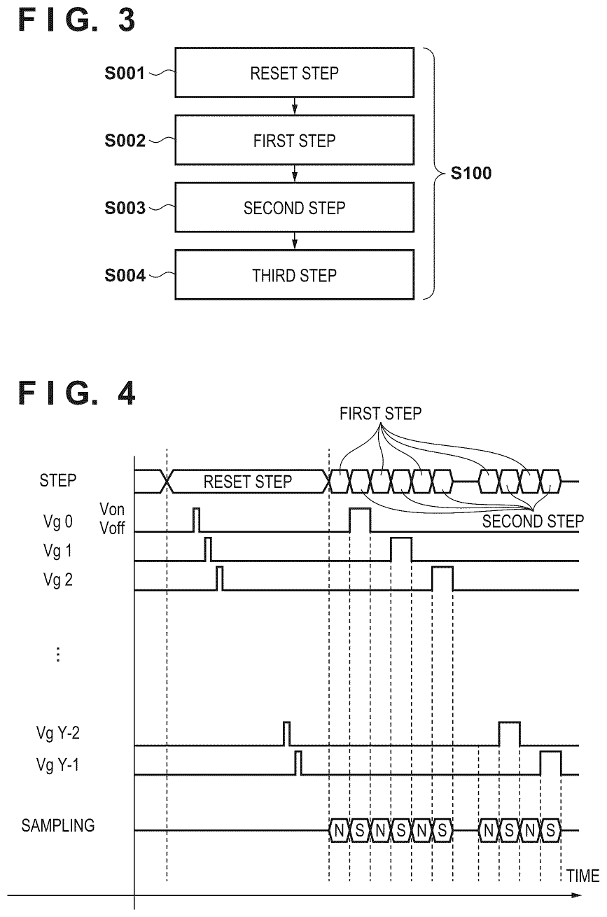

FIGS. 3 and 4 are a flowchart and a timing chart, respectively, illustrating when the radiation imaging apparatus performs a threshold voltage measurement operation S100 for each of the switching elements of the pixels. The radiation imaging apparatus is controlled by an operation method including the following steps shown in FIG. 3.
Reset step S001: The drive line Vg k is sequentially set to the conducting potential Von to discharge electric charges (dark charges generated by the dark current of the conversion element) accumulated in the conversion element 102 to the readout circuit 113, thereby resetting the conversion element.
First step S002: The potential of the drive line Vg 0 of the 0th row is set to the non-conducting potential Voff, thereby setting the switching elements of the 0th row in the non-conductive state. The readout circuit 113 measures an amount N of electric charge by the integral amplifier 105 based on the current flowing to the signal line for each column. An output from the integral amplifier 105 is input from the variable gain amplifier 104 of the readout circuit 113 to the sample and hold circuit 107. The sample and hold circuit 107 samples the output of the integral amplifier 105 at a timing indicated by “N” in an item “sampling” in FIG. 4. A sampled and held voltage is read via the multiplexer, and is output as digital data from the A/D converter 110. This digital data has a value corresponding to the amount N of electric charge. In this embodiment, data obtained by A/D-converting the data integrated and sampled and held in this way is set as an amount of electric charge. The thus measured amount N of electric charge is obtained by integrating the current flowing to each signal line during this step until the current settles down.
Second step S003: The drive line potential of the 0th row is set to the conducting potential Von, thereby setting the switching elements of the 0th row in the conductive state. The readout circuit 113 measures an amount S of electric charge by the integral amplifier for each column. An output from the integral amplifier 105 is sampled and held at a timing indicated by “S” in the item “sampling” in FIG. 4, and output, as digital data representing the amount S of electric charge, from the readout circuit 113 via the A/D converter 110. The amount S of electric charge is obtained by integrating the current flowing to each signal line during this step until the current settles down.
Third step S004: The difference between the amount N of electric charge and the amount S of electric charge is obtained based on the data obtained in the first step and the second step. In this way, the amount of electric charge along with transition of the gate potential in each switching element of the 0th row. As will be described later, the amount of electric charge of the difference between the amount N of electric charge and the amount S of electric charge includes information concerning the threshold voltage.

The amount of electric charge of the difference between the amount S of electric charge and the amount N of electric charge is an amount of electric charge obtained by integrating the current flowing while the switching element transitions from the non-conductive state to the conductive state. FIG. 4 shows a state in which after the reset step, The potential of the drive line Vg 0 of the 0th row is set to Voff, and set to Von, thereby obtaining the difference between the amount N of electric charge and the amount S of electric charge on the 0th row. After that, the first step and the second step are alternately executed for each row such as the first row and the second row, thereby performing measurement for all the rows. This can obtain, for all the pixels, the difference between the amounts of electric charge obtained in the first step and the second step.

The difference between the amounts of electric charge includes information concerning the threshold voltage of the switching element. Obtaining the information including the threshold voltage based on the difference between the amount N of electric charge and the amount S of electric charge will be described in detail later.

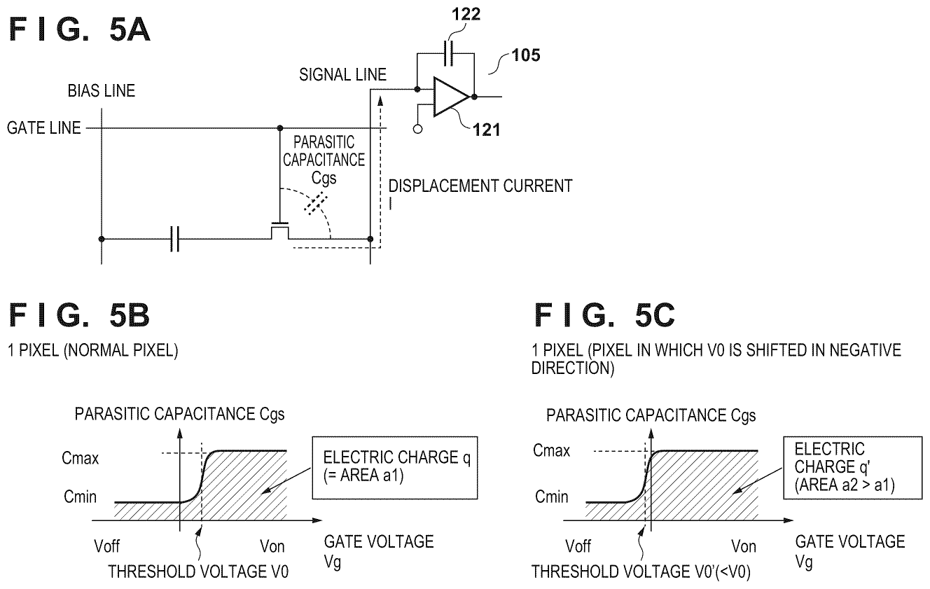

FIG. 5A shows an equivalent circuit diagram of one pixel of the sensor substrate by including a parasitic capacitance Cgs between the gate and the source as one parasitic capacitance of the switching element. Note that for the sake of descriptive convenience, to discriminate between the source electrode and the drain electrode of the switching element, the electrode connected to the signal line Sig will be referred to as the source electrode hereinafter and the electrode connected to the individual electrode will be referred to as the drain electrode hereinafter.

The parasitic capacitance Cgs changes in accordance with the potential of the drive line Vg k (indicated by the gate voltage Vg). FIG. 5B shows an example of a Cgs-Vg (capacitance Cgs-gate voltage Vg) curve representing the dependency of the parasitic capacitance Cgs on the gate voltage of a normal pixel. FIG. 5C shows an example of a curve representing the dependency of the parasitic capacitance Cgs on the gate voltage (Vg) of a pixel in which such abnormality occurs that the threshold voltage of the switching element shifts in the negative direction, as compared with the normal pixel. In general, the parasitic capacitance of the switching element changes depending on the gate voltage Vg, and the parasitic capacitance Cgs becomes large by a positive gate bias in an n-channel TFT. Therefore, the value of the parasitic capacitance Cgs increases after a threshold voltage V0, as shown in FIGS. 5B and 5C. If the drive line potential is switched from Voff to Von and each switching element is switched from the non-conductive state to the conductive state, the charge current (indicated by a displacement current I) of Cgs flows through the drive line and the signal line. Consider an amount q of electric charge obtained by integrating the current I flowing through the signal line in the readout circuit 113 connected to each signal line. In the normal pixel, the magnitude of q is represented by an area a1 of a hatched portion under the Cgs-Vg curve between Voff and Von, as shown in FIG. 5B. The amount q of electric charge corresponds to an amount of electric charge obtained by integrating the current flowing during transition from Voff to Von.

By using the amount N of electric charge and the amount S of electric charge obtained in the first step and the second step, the amount q of electric charge=the amount N of electric charge−the amount S of electric charge is obtained, and thus the approximate threshold voltage V0 of each pixel can be estimated from the magnitudes of the amount N of electric charge and the amount S of electric charge. Furthermore, if the shape of the Cgs-Vg curve, a maximum value Cmax of the parasitic capacitance, a minimum value Cmin of the parasitic capacitance, and the like are known, the threshold voltage V0 of the switching element can be estimated more correctly from the amount q of electric charge. In this embodiment, acquisition of the amount q of electric charge including the information concerning the threshold voltage V0 and estimation and measurement of the threshold voltage V0 will collectively be referred to as measurement of the threshold voltage V0 hereinafter.

If the threshold voltage V0 is different for each pixel, the Cgs-Vg curve is also different for each pixel. FIG. 5C shows an example of the Cgs-Vg curve of the pixel in which V0 shifts in the negative direction, as compared with the normal pixel, and the magnitude of an amount q′ of electric charge corresponding to an area a2 of a hatched portion between Voff and Von is larger than the amount q (corresponding to an area a1) of electric charge corresponding to the hatched area a1 shown in FIG. 5B. By setting, as a reference value, the amount q of electric charge measured in the normal pixel using the characteristic and comparing the amount q of electric charge with the amount q′ of electric charge measured in the abnormal pixel, an abnormality caused by deterioration of the switching element can be detected or determined.

In addition to the measurement of the amounts of electric charge and the detection of the characteristic of the switching element based on the amounts of electric charge, the threshold of the switching element can be estimated, as described above. To correctly estimate the threshold voltage V0 in each pixel, the influence of unnecessary electric charges in the photoelectric conversion element is preferably eliminated. To do this, (1) the reset step can be performed before the first step and the second step to remove the dark charges of the photoelectric conversion element. In addition, (2) it is recommended to prevent the irradiation dose of radiation to the radiation imaging apparatus from being changed during the first step and the second step, and it is further recommended not to perform radiation irradiation to the radiation imaging apparatus during the first step and the second step.

By using the threshold voltage V0 estimated above, the radiation imaging apparatus can determine or predict the life as the apparatus. As an example of the method of determining the life, a pixel in which the threshold voltage V0 of the switching element falls outside a predetermined range (for example, a range of +1 to −3 V) is defined as an abnormal pixel. Next, the characteristic of the switching element based on the threshold voltage of the pixel within an effective region is detected, and the controller determines whether the total number (abnormal number) D of abnormal pixels exceeds a predetermined allowable value Dmax. If D>Dmax, it may be considered that the radiation imaging apparatus has reached the end of life and the user may be notified, by an arbitrary method, that the apparatus should be exchanged.

As an example of the life prediction method, the transition of deterioration is predicted from the transition of the abnormal number D and the threshold voltage V0 for each pixel based on the temporal change of the threshold voltage V0 for each pixel, and time at which the abnormal number D exceeds the predetermined allowable value Dmax is estimated. The computer may measure and determine the threshold, and predict the life based on the information of the amount of electric charge output from the radiation imaging apparatus.

### Modification of First Embodiment

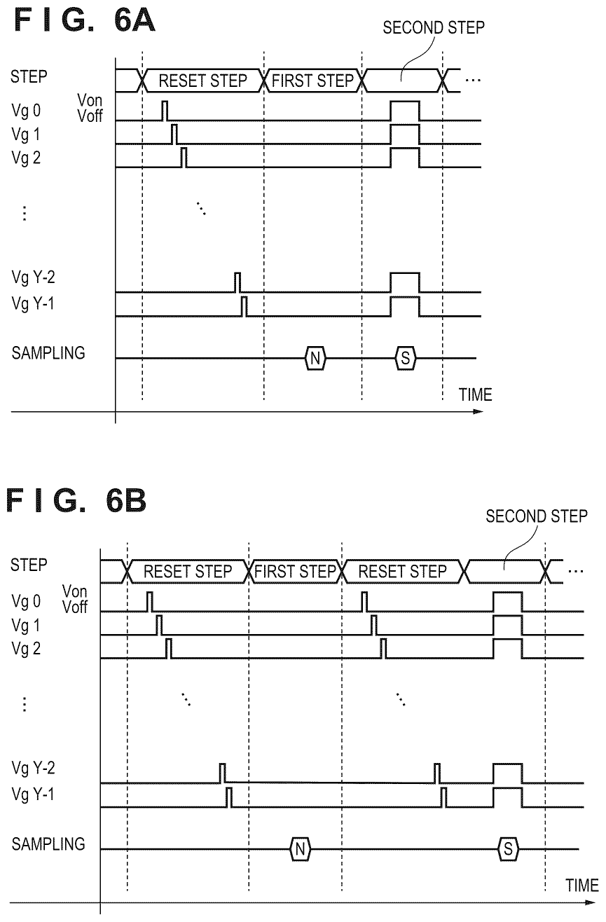

A modification of the first embodiment will be described next. In this embodiment, a measurement method of collectively obtaining the amounts of electric charge for all the rows of each column will be described. FIGS. 6A and 6B are timing charts in a case where the average value of the threshold voltages V0 over the entire pixel region is obtained. The timing chart shown in FIG. 6A will be described. In this case, the radiation imaging apparatus is controlled by an operation method including the following steps.
Reset step S001: This is the same as in the first embodiment.
First step S002: The drive line potentials Vg 0 of all the rows are set to the non-conducting potential Voff, thereby setting the switching elements of all the rows in the non-conductive state. Similar to the first embodiment, the integral amplifier 105 is used to integrate the current flowing to the signal line for each column, thereby outputting a voltage. After the sample and hold circuit of the readout circuit 113 holds the voltage from the integral amplifier 105 at a timing indicated by “N” in an item “sampling” in FIG. 6A, the readout circuit 113 outputs the data, and the A/D converter 110 outputs data indicating the amount N of electric charge, thereby ending the measurement of the amount N of electric charge.
Second step S003: The drive line potentials of all the rows are set to the conducting potential Von, thereby setting the switching elements of all the rows in the conductive state. Similar to the first embodiment, the integral amplifier 105 is used to integrate the current flowing to the signal line for each column, and a voltage corresponding to the output voltage of the integral amplifier 105 is sampled and held at a timing indicated by “S” in an item “sampling” in FIG. 6B, and output from the readout circuit 113. The output of the readout circuit 113 is A/D-converted to obtain digital data representing the amount S of electric charge, thereby ending the measurement of the amount S of electric charge.
Third step S004: In a method similar to that of the first embodiment, the difference between the amount S of electric charge and the amount N of electric charge is obtained, thereby obtaining, for each column, information including the threshold voltages V0 of the switching elements included in the pixels of all the rows. The pieces of information obtained for the respective columns are averaged for all the columns, thereby making it possible to measure the average value of the pieces of information including the threshold voltages V0 over the entire pixel region. In the modification, it is possible to obtain the sum of the amounts of electric charge of the pixels arranged in a column, the tendency of the threshold voltage V0 of the switching element is known. In this method as well, it is possible to detect deterioration of the overall radiation imaging apparatus.

Note that as described above, the first step and the second step may be continuously performed after the single reset step to obtain the amount N of electric charge and the amount S of electric charge, as shown in FIG. 6A, or the reset step may be performed before the first step and before the second step, as shown in FIG. 6B.

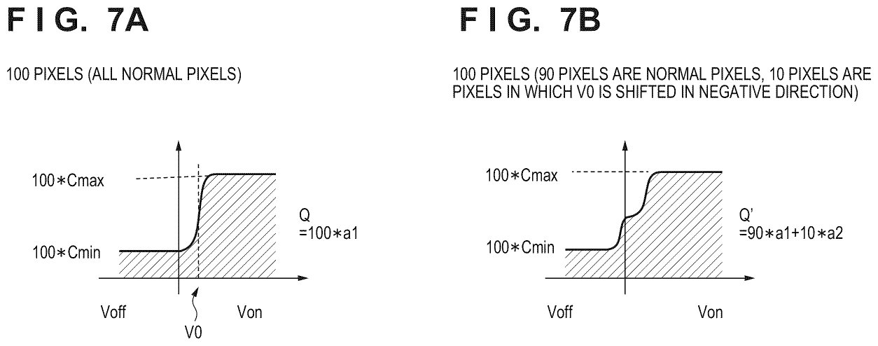

Threshold voltage measurement that can be performed in this modification will supplementarily be explained with reference to FIGS. 7A and 7B. To simplify the description, assume that the number of pixels forming the pixel region is 100 and all the pixels are normal pixels (threshold voltage V0) or abnormal pixels (threshold voltage V0′) similar to those shown in FIGS. 5B and 5C, respectively. FIG. 7A shows a Cgs-Vg curve in a case where all the 100 pixels are normal pixels, and FIG. 7B shows a Cgs-Vg curve in a case where 90 of the 100 pixels are normal pixels and the remaining 10 pixels are abnormal pixels.

In this modification, the sum of the amounts of electric charge for the 100 pixels at the time of Voff and Von can be obtained by performing the first step and the second step once. Referring to FIG. 7A, a magnitude Q of the amount of electric charge obtained by the first step and the second step is represented by 100 times of the area a1. On the other hand, referring to FIG. 7B, the sum of the amounts Q′ of electric charge for the 100 pixels can be represented by 90×a1+10×a2 using the areas a1 and a2 of the first embodiment. It can be said that if V0′ is a negative value smaller than V0, Q<Q′, and Q and Q′ reflect the average value of the threshold voltages over the entire pixel region.

Q or Q′ may be obtained by summing up the amounts of electric charge for the plurality of pixels, and the threshold voltage for each pixel cannot uniquely be determined. For example, it is impossible to separately obtain the number of pixels in each of which the threshold shifts, and the amount of the threshold shift. However, to determine or predict the life as the apparatus, it is often enough to obtain the average value of the threshold voltages for the entire pixel region or for each region, as described above. In this case, it is possible to implement determination or prediction of the life of the apparatus by the method and configuration simpler than those in the first embodiment.

### Second Embodiment

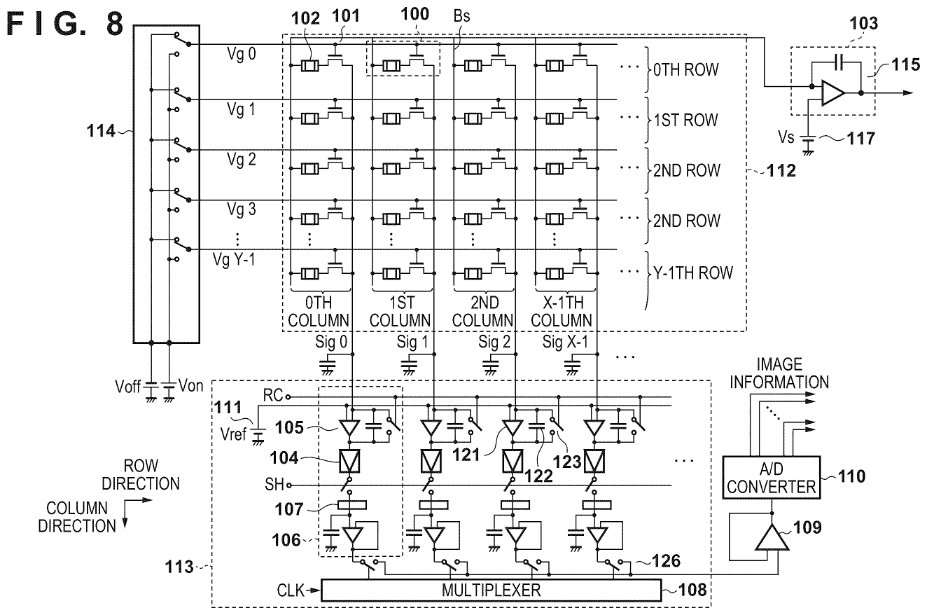

A radiation imaging apparatus according to this embodiment will be described with reference to FIG. 8. A description of the same components as in the first embodiment will be omitted. The difference between the first embodiment and this embodiment is that a bias power supply 103 is made to function as an amount of electric charge measurement unit.

The bias power supply 103 outputs a bias potential Vs. The bias power supply 103 functions as an amount of electric charge measurement unit, and thus includes an integral amplifier functioning as a charge-voltage conversion circuit, as shown in FIG. 8. The present disclosure is not limited to the integral amplifier as long as the circuit can measure an amount of electric charge from the bias power supply.

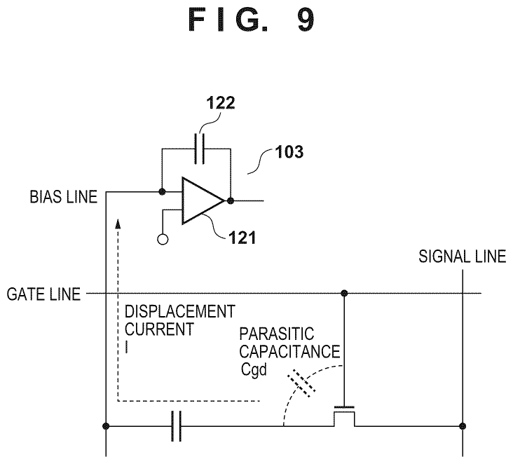

FIG. 9 shows an equivalent circuit diagram of one pixel of a sensor substrate shown in FIG. 8 by including a gate-drain capacitance (Cgd) as one parasitic capacitance of a switching element. Similar to FIG. 2B, Cgd depends on a gate voltage Vg, and increases after a threshold voltage V0. If a drive line potential is switched from Voff to Von, a charge current (a displacement current I) of Cgd flows from a drive line to a bias line. The parasitic capacitance Cgd changes depending on the gate voltage. If the threshold voltage of the switching element shifts, a Cgd-Vg curve also changes. An integral amplifier that functions as a charge-voltage conversion circuit is arranged in the bias power supply 103. An amount q of electric charge obtained by integrating, by an integral amplifier 105, the displacement current I flowing through the bias line corresponds to an area under the Cgd-Vg curve. Based on this, a change in threshold voltage of the switching element can be obtained from a difference in amount q of electric charge by the same procedure as in the first embodiment. Therefore, it is possible to estimate the threshold voltage V0 for each pixel or the average value of the threshold voltages V0 for each region or for the entire pixel region.

Since the bias line is a common wiring for all the pixels, and is collectively connected to all the pixels, it is more convenient than in the first embodiment to obtain the average value of pieces of information including the threshold voltages V0 over the entire pixel region.

This embodiment has explained an example of arranging the amount of electric charge measurement unit in the bias power supply 103. However, an amount of electric charge measurement unit may be provided as an individual circuit separately from the bias power supply 103 to measure an amount of electric charge based on the displacement current I flowing through the bias line.

Furthermore, the amount of electric charge measurement unit may measure an amount of electric charge based on a control current flowing to the drive line instead of measuring the amount of electric charge based on the signal current of the signal line or the bias current of the bias line. In this case, an integral circuit configured to integrate a current flowing to each of the drive line laid out from Voff to each gate and the drive line laid out from Von to each gate may be provided in each drive line. In this case, the amounts of electric charge at the time of Voff and Von are measured based on the output voltage of the integral circuit provided in each drive line, and the difference between the amounts may be set as an amount of electric charge when the potential transitions from Voff to Von. If the current flowing through the drive line is measured, an amount of electric charge is measured by the amount of electric charge measurement unit based on the total value of the charge current to Cgs and the charge current to Cgd. Information concerning the threshold voltage that can be obtained based on the amount of electric charge is the same as in a case where the amount of electric charge flowing to the signal line is measured or a case where the amount of electric charge flowing to the bias line is measured.

Note that in the above description, the drive line potential is changed from Voff to Von. This order may be reversed (the potential may be changed from Von to Voff). Since the positive and negative signs of the displacement current I and the amount of electric charge are inverted but the magnitudes remain unchanged, the same discussion as in the above description can be held. It is also possible to reverse the order of the first step and the second step in each of the above-described embodiments.

The present disclosure is not limited to the above embodiments and various changes and modifications can be made within the spirit and scope of the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-009602, filed, Jan. 25, 2024 which is hereby incorporated by reference herein in its entirety.

What is claimed is:

1. A method of operating a radiation imaging apparatus that includes
a plurality of pixels, with each pixel of the plurality of pixels including a conversion element configured to convert radiation or light into an electric charge and to accumulate the electric charge, and a switching element configured to read an electrical signal corresponding to the electric charge;
a bias power supply configured to supply a bias potential to the conversion element via a bias line;
a drive circuit configured to supply a control signal to a control electrode of the switching element via a drive line and to control the switching element;
a readout circuit configured to read an electrical signal from the switching element via a signal line;
and
a controller,
the method comprising:
measuring an amount of electric charge based on a current flowing through one of the signal line, the bias line, and the drive line while the switching element transitions from a non-conductive state to a conductive state or from a conductive state to a non-conductive state; and
determining, by the controller, a characteristic of the switching element based on the measured amount of electric charge.

2. The method according to claim 1, wherein
the amount of electric charge is measured while the switching element provided in each pixel of the plurality of pixels transitions from the non-conductive state to the conductive state or from the conductive state to the non-conductive state, and
the characteristic of the switching element is determined based on the measured amount of electric charge in each pixel of the plurality of pixels.

3. The method according to claim 1, wherein the amount of electric charge is measured after reset of the conversion element.

4. The method according to claim 1, further comprising:
measuring, in a case where the switching element is in the non-conductive state, a first amount of electric charge;
measuring, in a case where the switching element is in the conductive state, a second amount of electric charge; and
obtaining a difference between the first amount of electric charge and the second amount of electric charge.

5. The method according to claim 1, wherein the switching element includes a channel layer that comprises an oxide semiconductor.

6. The method according to claim 1, wherein the characteristic of the switching element is determined by comparing the measured amount of electric charge with a predetermined reference value.

7. The method according to claim 1, wherein the characteristic of the switching element includes information concerning a threshold voltage of the switching element.

8. The method according to claim 7, further comprising determining, by the controller, a state of the radiation imaging apparatus by comparing an allowable value with a number of switching elements whose information concerning the threshold voltage falls outside a predetermined range.

9. The method according to claim 1, wherein the amount of electric charge is measured by one of the readout circuit, the bias power supply, and an amount of electric charge measurement unit.

10. The method according to claim 9, wherein the amount of electric charge measurement unit includes an integral amplifier.

11. A radiation imaging apparatus comprising:
a plurality of pixels, with each pixel of the plurality of pixels including a conversion element configured to convert radiation or light into an electric charge and to accumulate the electric charge, and a switching element configured to read an electrical signal corresponding to the electric charge;
a bias power supply configured to supply a bias potential to the conversion element via a bias line;
a drive circuit configured to supply a control signal to a control electrode of the switching element via a drive line and to control the switching element;
a readout circuit configured to read an electrical signal from the switching element via a signal line; and
a controller,
wherein an amount of electric charge is measured based on a current flowing through one of the signal line, the bias line, and the drive line while the switching element transitions from a non-conductive state to a conductive state or from a conductive state to a non-conductive state, and
a characteristic of the switching element is determined by the controller based on the amount of electric charge.

12. The apparatus according to claim 11, wherein
the amount of electric charge is measured while the switching element provided in each pixel of the plurality of pixels transitions from the non-conductive state to the conductive state or from the conductive state to the non-conductive state, and
the controller determines the characteristic of the switching element based on the measured amount of electric charge in each of the plurality of pixels.

13. The apparatus according to claim 11, wherein the amount of electric charge is measured after reset of the conversion element.

14. The apparatus according to claim 11, wherein the controller is further configured to obtain a difference between a first amount of electric charge and a second amount of electric charge,
wherein the first amount of electric charge is measured in a case where the switching element is in the non-conductive state, and
wherein the second amount of electric charge measured in a case where the switching element is controlled to the conductive state.

15. The apparatus according to claim 11, wherein the switching element includes a channel layer that comprises an oxide semiconductor.

16. The apparatus according to claim 11, wherein the characteristic of the switching element is determined by comparing the measured amount of electric charge with a predetermined reference value.

17. The apparatus according to claim 11, wherein the characteristic of the switching element includes information concerning a threshold voltage of the switching element.

18. The apparatus according to claim 17, wherein the controller is further configured to determine a state of the radiation imaging apparatus by comparing an allowable value with a number of switching elements whose information concerning the threshold voltage falls outside a predetermined range.

19. The apparatus according to claim 11, wherein the amount of electric charge is measured by one of the readout circuit, the bias power supply, and an amount of electric charge measurement unit.

20. The apparatus according to claim 19, wherein the amount of electric charge measurement unit includes an integral amplifier.
